(19) United States
(12) Patent Application Publication
(10) Pub. No.: US 2011/0241603 A1
(43) Pub. Date: Oct. 6, 2011

(54) PORTABLE POWER SUPPLY DEVICE

(75) Inventors: Po-Yuan Chang, Hsin-Chu (TW); Nan-Jiun Yin, Hsin-Chu (TW); Jui-Chi Chen, Hsin-Chu (TW)

(73) Assignee: CORETRONIC CORPORATION, Hsin-Chu (TW)

(21) Appl. No.: 12/986,179

(22) Filed: Jan. 7, 2011

(30) Foreign Application Priority Data
Mar. 31, 2010 (CN) 201020165831.1

(51) Int. Cl. H01M 10/46; H02J 7/00

(52) U.S. Cl. 320/101; 320/108

(57) ABSTRACT

A portable power supply device including a power storage module, a charging module, and a power supply module is provided. The power storage module is electrically connected to the charging module and is used for storing electric power. The charging module wirelessly receives energy from a first power source and charges the power storage module by using the received energy. The power supply module is electrically connected to the power storage module, and is used for wirelessly supplying electric power stored in the power storage module to a first external device. Since the portable power supply device may wirelessly receive and wirelessly output power and a power connector is eliminated, a utilization range of the portable power supply device is not limited by a length of a power line and a situation of the portable power supply device being unusable due to mismatch of the power connector may be avoided.

### CROSS-REFERENCE TO RELATED APPLICATION

This application claims the priority benefit of Chinese application serial no. 201020165831.1, filed on Mar. 31, 2010. The entirety of the above-mentioned patent application is hereby incorporated by reference herein and made a part of this specification.

### BACKGROUND

1. Field of Invention

The invention relates to a portable power supply device. More particularly, the invention relates to a portable power supply device capable of wirelessly receiving energy for charging and wirelessly supplying energy to other external devices.

2. Description of Related Art

In U.S. Patent Application No. 2009/0106567, Baarman et al. disclose a power supply station. Referring to FIG. 1, a power supply station 10 is an inductive device, and wirelessly supply power to a laptop L or other devices. The power supply station 10 has a carriage 12 and a power supplier 14, and the carriage 12 has a pair of mutually separated walls 16a and 16b and swivelling feet 60.

Moreover, Taiwan utility model patent No. 551560 discloses an inductive power supply device for a wireless mouse. Referring to FIG. 2, FIG. 3 and FIG. 4, an induction coil L2 is disposed at bottom in internal of the wireless mouse 201, and is connected in parallel to a capacitor C1 of a power supply circuit PC, so as to form a parallel resonant circuit. The parallel resonant circuit is coupled to a charging capacitor C2 through a diode D, so as to form an inductive power supply circuit. A working voltage of two ends of the charging capacitor C2 is outputted through an electric connection terminal P. A coil L1 is embedded in a mouse pad 202, and the coil L1 is connected to a power line W to receive power. When the wireless mouse 201 is put on the mouse pad 202 and the power is inputted to the coil L1 of the mouse pad 202, the coil L1 generates a magnetic wave signal. When the magnetic wave signal is received by the induction coil L2 within the wireless mouse 201, the induction coil L2 generates an electromotive force (EMF), and forms parallel resonant with the capacitor C1 of the power supply circuit PC. A resonant signal charges the charging capacitor C2 through the diode D. Moreover, a charging battery B is coupled to the charging capacitor C2 in parallel.

However, regardless of the above power supply station 10 or the mouse pad 202, it has to first receive external power through a power line (for example, the power line W), and then the received power is transmitted to other devices (for example, the wireless mouse 201) wirelessly. Therefore, before the power supply station 10 or the mouse pad 202 is utilized, the power supply 10 or the mouse pad 202 has to be first connected to the external power through the power line to normally operate the power supply station 10 or the mouse pad 202, though it causes a utilization inconvenience.

### SUMMARY

The invention is directed to a portable power supply device. The portable power supply device may wirelessly receive power to charge a power storage module of the portable power supply device, and may wirelessly provide power to external devices.

Additional aspects and advantages of the invention will be set forth in the description of the techniques disclosed in the invention.

To achieve one of or all aforementioned and other advantages, an embodiment of the invention provides a portable power supply device. The portable power supply device includes a power storage module, a charging module, and a power supply module. The power storage module is used for storing electric power. The charging module is electrically connected to the power storage module, wirelessly receives energy from a first power source, and charges the power storage module by using the received energy. The power supply module is electrically connected to the power storage module, and is used for wirelessly supplying the electric power stored in the power storage module to a first external device.

In an embodiment of the invention, the charging module includes a first coil, and the first coil is used for inducing electromagnetic wave emitted from the first power source to generate an electromotive force (EMF) for charging the power storage module.

In an embodiment of the invention, the charging module further receives another energy from the first power source through a cable and charges the power storage module by using the received energy.

In an embodiment of the invention, the charging module includes a connector, and the connector is electrically connected to a second power source. The charging module receives another energy from the second power source.

In an embodiment of the invention, the charging module includes a solar panel. The solar panel is used for converting light energy of received light into a converted electric power, and the converted electric power is used to charge the power storage module.

In an embodiment of the invention, the power supply module includes a second coil, and the second coil is used for converting the electric power stored in the power storage module into electromagnetic wave.

In an embodiment of the invention, the power supply module further includes a driver, a current detector, and a controller. The driver is electrically connected to the second coil for driving the second coil, and the second coil converts the electric power stored in the power storage module into electromagnetic wave. The current detector is electrically connected to the driver for detecting a current of the driver. The controller is electrically connected to the current detector for controlling operations of the driver according to a detecting result of the current detector.

In an embodiment of the invention, the power supply module further supplies the electric power stored in the power storage module to a second external device through a cable.

In an embodiment, the power supply module includes a converter and a connector. The converter is used for converting the electric power stored in the power storage module into a direct current (DC) voltage. The connector is electrically connected to a second external device, and the power supply module supplies the direct current voltage to the second external device.

In an embodiment of the invention, the power storage module includes a Ni-MH battery or a lithium battery.

According to the above descriptions, the embodiment of the invention has at least one of the following advantages. In an area without power supply, the portable power supply device of the embodiment may provide the most immediate power supply by itself. When the portable power supply device supplies power wirelessly, the power supplying is not limited by shapes of connectors so the portable power supply device may supply power to different devices and problems such as power line entangling and short circuit are avoided. Accordingly, it is safe and reliable in utilization. Moreover, when the portable power supply device supplies power wirelessly, since the power transmission is totally controlled by the power supply module, it is unnecessary to pay special attention to designed parameters such as a voltage value and a current value, etc. of the product to be charged. Afterwards, besides the wireless power-supply approach, the conventional cable power-supply approach is also reserved for the portable power supply device. Accordingly, if the product to be charged does not have a wireless power receiving function, the conventional cable power-supply approach may be used. Besides, when the cable or wireless charging is not available, the portable power supply device may still generate power and charge power through its solar panel.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a power supply station.

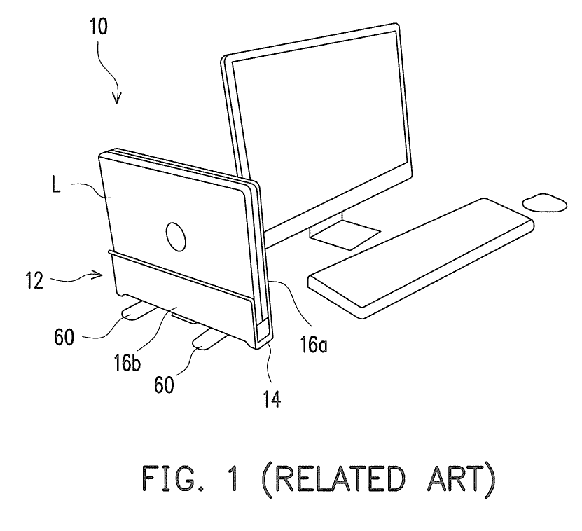

FIG. 2 is a cross-sectional view of a wireless mouse and a mouse pad.

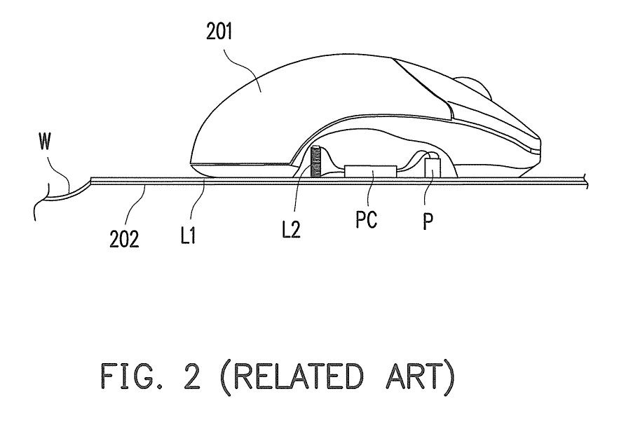

FIG. 3 is a circuit diagram of a power supply circuit of FIG. 2

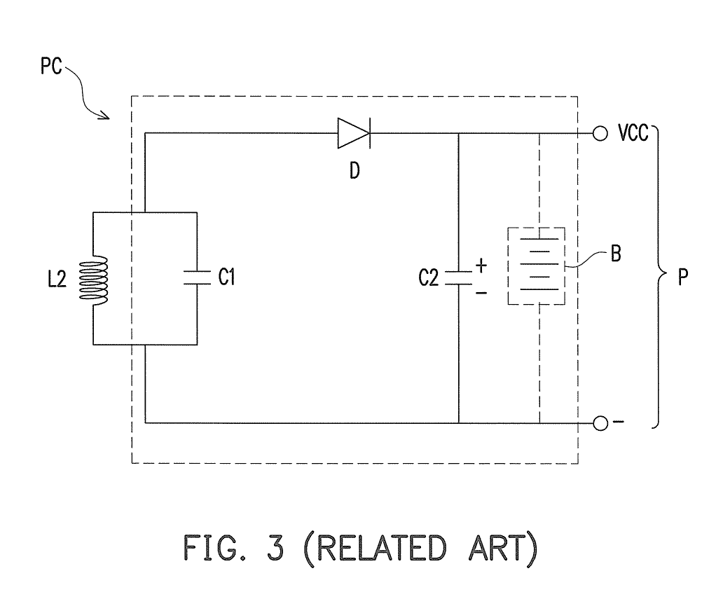

FIG. 4 is a top view of a wireless mouse of FIG. 2 located on a mouse pad.

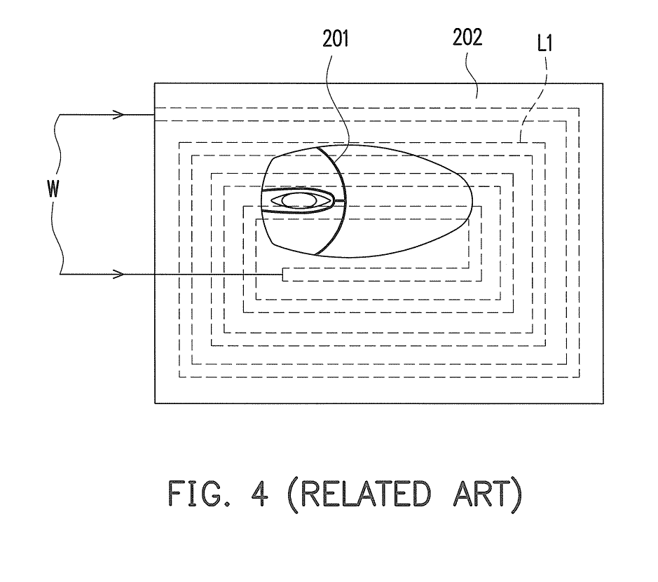

FIG. 5 is a functional block diagram illustrating a portable power supply device, a first power source and a first external device according to an embodiment of the invention.

FIG. 6 is a functional block diagram illustrating a portable power supply device, a first power source, a second power source, a first external device, and a second external device according to an embodiment of the invention.

FIG. 7 is a diagram illustrating utilization of a portable power supply device according to an embodiment of the invention.

FIG. 8 is a schematic diagram illustrating a portable power supply device according to an embodiment of the invention.

### DETAILED DESCRIPTION OF DISCLOSED EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

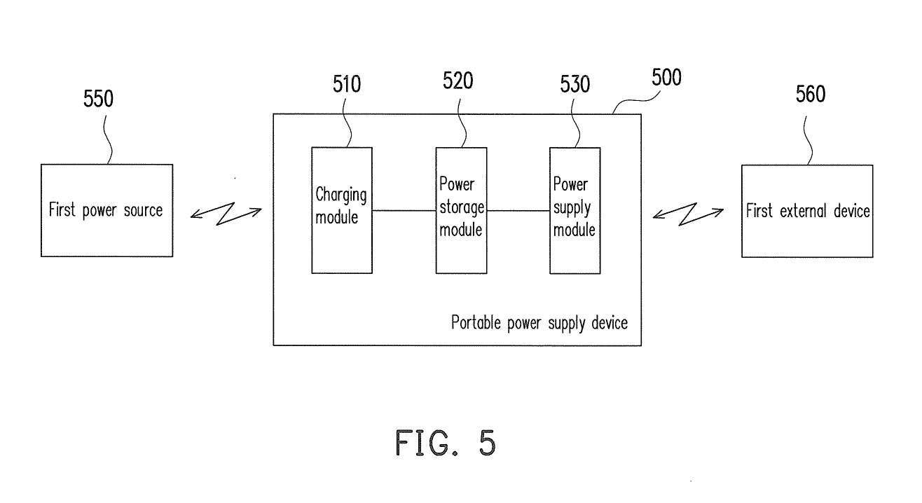

Referring to FIG. 5, FIG. 5 illustrates a portable power supply device 500, a first power source 550, and a first external device 560 according to an embodiment of the invention. The portable power supply device 500 includes a charging module 510, a power storage module 520, and a power supply module 530. The power storage module 520 is used for storing electric power. In an embodiment of the invention, the power storage module 520 may be a Ni-MH battery. In another embodiment of the invention, the power storage module 520 may be a lithium battery. Though the invention is not limited thereto, those skilled in the art should understand that the power storage module 520 may also be other apparatus or device having charge and discharge functions. Moreover, the charging module 510 is electrically connected to the power storage module 520, wirelessly receives energy from the first power source 550, and charges the power storage module 520 by using the received energy. The power supply module 530 is electrically connected to the power storage module 520 and is used for wirelessly supplying the electric power stored in the power storage module 520 to the first external device 560.

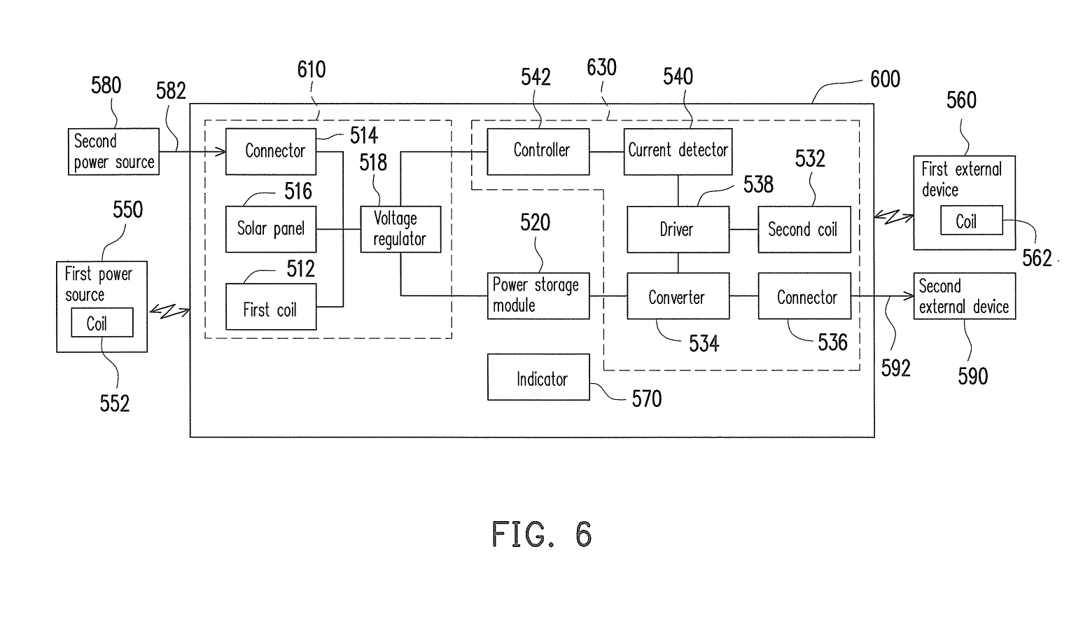

Referring to FIG. 6, FIG. 6 illustrates a portable power supply device 600, a first power source 550, a second power source 580, a first external device 560, and a second external device 590 according to an embodiment of the invention. As shown in FIG. 6, the portable power supply device 600 may also receive energy from the second power source 580 through a cable to charge the power storage module 520 by using the received energy. In detail, the portable power supply device 600 includes a charging module 610, the power storage module 520, and a power supply module 630. In the embodiment, the charging module 610 includes a first coil 512, a connector 514, a solar panel 516, and a voltage regulator 518. The first coil 512 may induce electromagnetic wave emitted from a coil 522 of the first power source 550 to generate an electromotive force (EMF) for charging the power storage module 520. The solar panel 516 may convert light energy of the received light into a converted electric power, and the converted electric power is used to charge the power storage module 520. The connector 514 is electrically connected to the second power source 580 through a power line 582, and the charging module 610 may receive energy from the second power source 580. The voltage regulator 518 is used for regulating the voltages from the first coil 512, the connector 514, and the solar panel 516, and the voltage regulator 518 charges the power storage module 520 by using the regulated voltages.

The power supply module 630 includes a second coil 532, and the second coil 532 is used for converting the electric power stored in the power storage module 520 into electromagnetic wave. A coil 562 of the first external device 560 may induce the electromagnetic wave generated by the second coil 532 to generate an electromotive force for driving the first external device 560. The power supply module 630 further includes a driver 538, a current detector 540, and a controller 542. The driver 538 is electrically connected to the second coil 532 for driving the second coil 532, and the second coil 532 converts the electric power stored in the power storage module 520 into electromagnetic wave. The current detector 540 is electrically connected to the driver 538 for detecting a current of the driver 538. The controller 542 is electrically connected to the current detector 540, and controls the operations of the driver 538 according to a detecting result of the current detector 540. Moreover, the power supply module 630 of the present embodiment may also supply the electric power stored in the power storage module 520 to the second external device 590 through a cable 592. In detail, the power supply module 630 further includes a converter 534 and a connector 536. The converter 534 is used for converting the electric power stored in the power storage module 520 into a direct current (DC) voltage. The connector 536 is electrically connected to the second external device 590, and the power supply module 630 supplies the direct current voltage output by the converter 534 to the second external device 590.

However, in the above embodiment, the first coil 512 and the second coil 532 are unnecessarily to be two independent coils, that is, the first coil 512 and the second coil 532 may be combined into one coil.

Moreover, in an embodiment of the invention, the portable power supply device 600 further includes an indicator 570, and the indicator 570 is used for indicating a charging state or a power supplying state of the power storage module 520. In an embodiment of the invention, the indicator 570 is a display device including a plurality of light-emitting elements, and the light-emitting elements are, for example, light-emitting diodes (LEDs). In an embodiment of the invention, the indicator 570 is a display, and the indicator 570 may display the state of the power storage module 520 through graphics or text. Moreover, in an embodiment of the invention, besides the charging state or the power supplying state of the power storage module 520, the indicator 570 may further display other status of the portable power supply device 600, for example, a status indicating abnormity of a certain device of the portable power supply device 600.

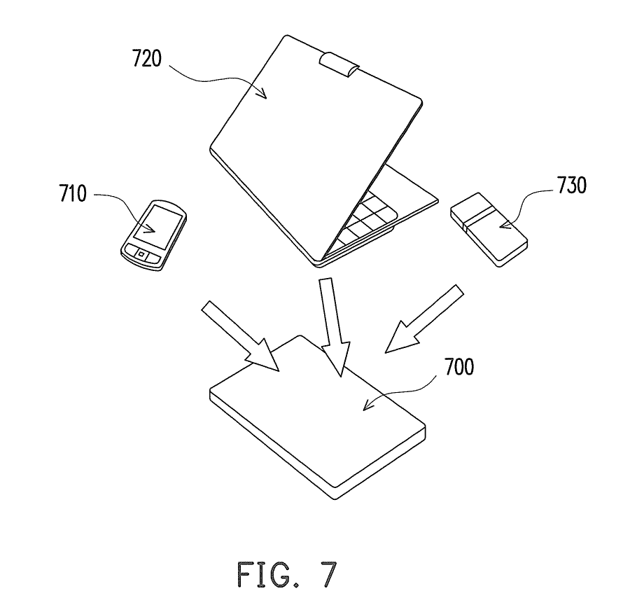

Referring to FIG. 7, when a user uses a portable power supply device 700 to supply power to an electronic device (for example, a mobile phone 710, a laptop 720, or a micro projector 730, etc.), the electronic device may be disposed on the portable power supply device 700, and the portable power supply device 700 may provide power to the electronic device wirelessly.

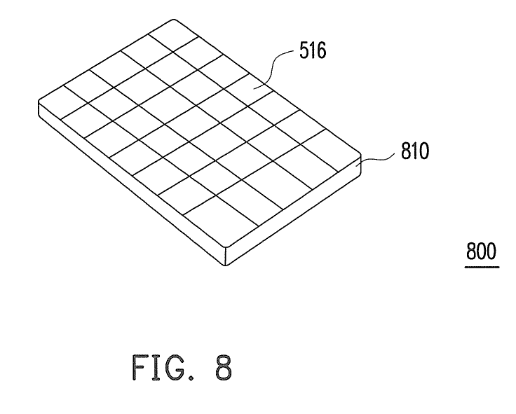

Referring to FIG. 8, a portable power supply device 800 includes a casing 810, and the solar panel 516 of the portable power supply device 800 is disposed on a surface of the casing 810. When the portable power supply device 800 is in an idle state, the power storage module 520 of the portable power supply device 800 may be charged through the solar panel 516.

In summary, the embodiment or embodiments of the invention may have at least one of the following advantages. A size of the portable power supply device is flexible to satisfy different utilization requirements. Moreover, in an area without power supply, the portable power supply device may provide the most immediate power supply by itself. When the portable power supply device supplies power wirelessly, since the power supplying is not limited by a shape of the connector, the portable power supply device may supply power to different devices; and since problems such as power line entangling and short circuit are avoided, it is safe and reliable in utilization. Moreover, when the portable power supply device supplies power wirelessly, since the power transmission is totally controlled by the power supply module, it is unnecessary to pay special attention to designed parameters such as a voltage value, a current value, etc. of the product to be charged. Afterwards, besides the wireless power-supply approach, the conventional cable power-supply approach is also reserved for the portable power supply device. Accordingly, if the product to be charged does not have a wireless power receiving function, the conventional cable power-supply approach may be used. Besides, when the cable or wireless charging is not available, the portable power supply device may still generate power and charge power through its solar panel.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A portable power supply device, comprising:
a power storage module, for storing electric power;
a charging module, electrically connected to the power storage module, wirelessly receiving energy from a first power source, and charging the power storage module by using the received energy; and
a power supply module, electrically connected to the power storage module, for wirelessly supplying the electric power stored in the power storage module to a first external device.

2. The portable power supply device as claimed in claim 1, wherein the charging module comprises a first coil, and the first coil is used for inducing electromagnetic wave emitted from the first power source to generate an electromotive force for charging the power storage module.

3. The portable power supply device as claimed in claim 1, wherein the charging module further receives another energy from the first power source through a cable and charges the power storage module by using the received energy.

4. The portable power supply device as claimed in claim 1, wherein the charging module comprises a connector, the connector is electrically connected to a second power source, and the charging module receives another energy from the second power source.

5. The portable power supply device as claimed in claim 1, wherein the charging module comprises a solar panel, the solar panel is used for converting light energy of received light into a converted electric power, and the converted electric power is used to charge the power storage module.

6. The portable power supply device as claimed in claim 1, wherein the power supply module comprises: a second coil, for converting the electric power stored in the power storage module into electromagnetic wave.

7. The portable power supply device as claimed in claim 6, wherein the power supply module further comprises: a driver, electrically connected to the second coil for driving the second coil, and the second coil converts the electric power stored in the power storage module into electromagnetic wave; a current detector, electrically connected to the driver, for detecting a current of the driver; and a controller, electrically connected to the current detector, for controlling operations of the driver according to a detecting result of the current detector.

8. The portable power supply device as claimed in claim 1, wherein the power supply module further supplies the electric power stored in the power storage module to a second external device through a cable.

9. The portable power supply device as claimed in claim 1, wherein the power supply module comprises: a converter, for converting the electric power stored in the power storage module into a direct current voltage; and a connector, electrically connected to a second external device, and the power supply module supplies the direct current voltage to the second external device.

10. The portable power supply device as claimed in claim 1, wherein the power storage module comprises a Ni-MH battery or a lithium battery.
